(19) United States
(12) Patent Application Publication
(10) Pub. No.: US 2007/0284880 A1
(43) Pub. Date: Dec. 13, 2007

(54) Pipe Connection System

(75) Inventor: Robert Michael Zirin, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 11/422,902

(22) Filed: Jun. 8, 2006

(51) Int. Cl. F16L 17/00

(52) U.S. Cl. 285/376

(57) ABSTRACT

A connector including a male adapter and a female adapter is provided. The male adapter includes a first base structure and a neck structure protruding out of the base structure. The neck structure includes a multiple of first lobes extending radially outward from the neck structure. The first lobes include a first mating surface contour on a bottom surface. The female adapter includes a second base structure. The second base structure includes a second mating surface contour on a top surface and is configured to fit into said first mating surface contour thereby compressing a face seal to induce a compressive stress between said male and said female adapter.

### BACKGROUND

The invention relates generally to lobed connectors, and more particularly to lobed connectors in pipe systems.

Gasification Technologies provide a stable, affordable energy supply and high efficiency with near-zero pollutants. Gasification based systems also provide flexibility in the production of a wide range of products including electricity, fuels, chemicals, hydrogen, and steam. More importantly, in a time of electricity- and fuel-price spikes, flexible gasification systems provide for operation on low-cost, widely-available feedstocks.

One of the critical factors in gasification plant economics is maintenance. The ease of maintaining the equipment and equipment reliability can lead to a significant reduction in the overall downtime of the plant. Moreover, an easier process of assembly and disassembly of equipment is also an important factor in facilitating easier maintenance. An improvement in these factors results in enhanced productivity of the plant.

A coal gasification feed injector nozzle used in a gasification plant generally includes three concentric pipes with portions of the nozzle welded to ends of each pipe. Such a design is referred to as a non-modular design. Flanges used to connect the pipes are unbolted during disassembly of the pipes. Further, the inner pipe is pulled out through the middle pipe and the middle pipe is pulled out through the outer pipe. Feed injector performance has been improved upon by introduction of a nozzle design that features a flared inner nozzle section, which makes it impossible to pull out the inner pipe during disassembly. For this reason, the improved nozzle has been designed to be modular, wherein the entire nozzle is bolted onto adapters on the pipes. Such a design makes pulling the inner pipe out convenient during disassembly as the entire nozzle can first be unbolted and removed. However, the modular design is generally not practical due to bolting, sealing and fabrication cost issues.

Therefore, it would be desirable to have a design that would address the aforementioned problems.

### BRIEF DESCRIPTION

In accordance with one aspect of the invention, a connector is provided. The connector includes a male adapter including a first base structure and a neck structure protruding out of the said base structure. The neck structure includes a plurality of first lobes extending radially outward from the neck structure. The plurality of first lobes further includes a first mating surface contour on a bottom surface. The connector also includes a female adapter. The female adpater includes a second base structure that includes a plurality of second lobes extending radially inward from the second base structure having a second mating surface contour on a top surface. The second mating surface contour is configured to fit into the first mating surface contour thereby compressing a face seal to induce a compressive stress between the male and the female adapter.

In accordance with another aspect of the invention, a gasification system is included. The gasification system includes a first end of a first gas pipe configured to connect to a male adapter that includes a first base structure and a neck structure protruding out of the base structure. The neck structure includes a plurality of first lobes extending radially outward from the neck structure. The plurality of first lobes also includes a first mating surface contour on a bottom surface. The gasification system also includes a first end of a second gas pipe configured to connect to the first end of the first gas pipe via a female adapter including a second base structure. The second base structure includes a plurality of second lobes extending radially inward from the second base structure having a second mating surface contour on a top surface. The second mating surface contour is configured to fit into the first mating surface contour thereby compressing a face seal to induce a compressive stress between the male and the female adapter.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatic illustration of an exemplary gasification pipe connection system in accordance with an embodiment of the invention;

FIG. 2 is a diagrammatic illustration of the male adapter in FIG. 1 in accordance with an embodiment of the invention;

FIG. 3 is a diagrammatic illustration of the female adapter in FIG. 1 in accordance with an embodiment of the invention;

FIG. 4 is a diagrammatic illustration of a dowel stop configuration of the male adapter and the female adapter in FIG. 1 in accordance with an embodiment of the invention;

FIG. 5 is a diagrammatic illustration of a ratchet stop configuration of the male adapter and the female adapter in FIG. 1 in accordance with an embodiment of the invention;

FIG. 6 is a diagrammatic illustration of a two way release configuration of the male adapter and the female adapter in FIG. 1 in accordance with an embodiment of the invention; and

FIG. 7 is a diagrammatic illustration of a no way release configuration of the male adapter and the female adapter in FIG. 1 in accordance with an embodiment of the invention.

### DETAILED DESCRIPTION

As discussed in detail below, embodiments of the present invention include an improved connection system, wherein the connection system provides a boltless and flangeless mechanism of connecting objects such as gas pipes with desirable sealing. The connection system includes a twist-on mechanism during assembly and twist-off mechanism during disassembly of the objects that makes it convenient for usage. A seal compression force prevents joints that are connected from coming apart.

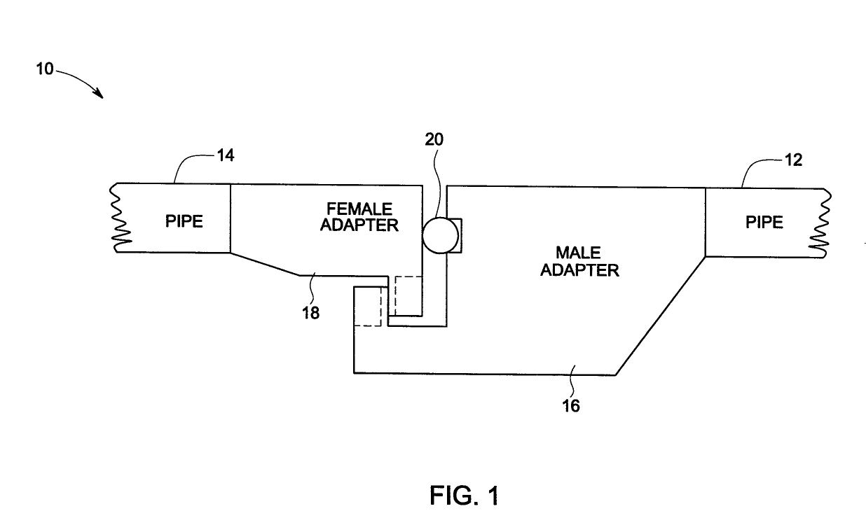

In an illustrated embodiment of the invention as shown in FIG. 1, a cross-sectional view of an exemplary gasification pipe connection system 10 is shown. The system 10 includes two pipes 12 and 14 that are connected to each other via a male adapter 16 and a female adapter 18. An end of the pipe 12 is attached to the male adapter 16 while an end of the pipe 14 is attached to the female adapter 18. An annular seal ring 20 provides sealing between the male adapter 16 and the female adapter 18 enabling a desirably tight connection. The male adapter 16 and the female adapter 18 may be fitted inside the pipes 12 and 14 so as to enable desirable clearance outside. In an example, the male adapter 16 and the female adapter 18 are welded inside ends of the pipes 12 and 14 respectively.

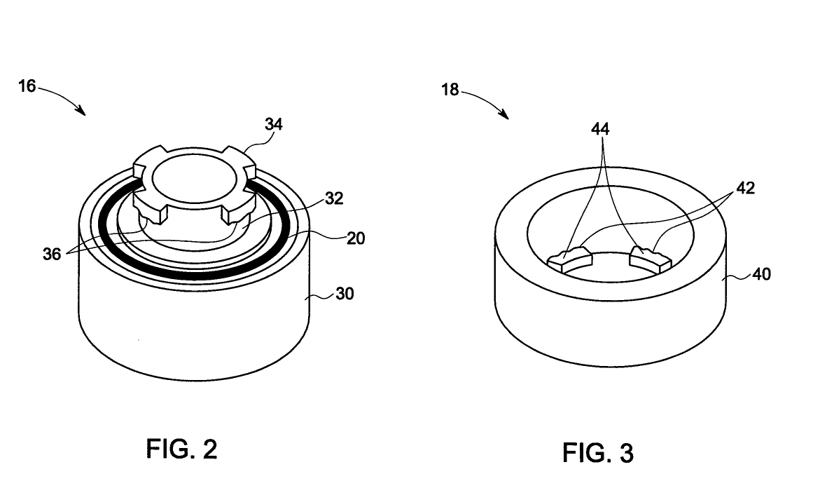

FIG. 2 is a diagrammatical illustration of an exemplary embodiment of the male adapter 16 as referenced to in FIG. 1. The male adapter 16 includes a first base structure 30 and a neck structure 32 that protrudes out of the first base structure 30. The base structure 30 includes the seal ring 20 as referenced to in FIG. 1. The seal ring 20 may include a material that requires minimal torque for installation while maintaining an effective seal. In an example, the seal ring 20 may include a rubber O-ring seal. The neck structure 32 includes a plurality of first lobes 34 that extend radially outward from the neck structure 32. Each of the first lobes 34 includes a first mating surface contour on a bottom surface 36. The lobes 34 are circumferential flange sections internal to the male adapter 16. In an example, the neck structure 32 may include a hollow annular structure. In another example, the first base structure 30 may include a hollow annular structure. As shown in FIG. 1, the male adapter 16 is welded internal to a pipe 12. This may lead to a constriction in flow area of a liquid or gas through the pipe 12. Hence, providing a hollow structure for the male adapter 16 would minimize constriction in the flow of the liquid or gas. Further, it may be desirable to provide a pipe of a diameter slightly larger than that of the flow area in order to accommodate for the constriction in flow.

FIG. 3 is a diagrammatical illustration of an exemplary embodiment of the female adapter 18 as referenced to in FIG. 1. The female adapter 18 includes a second base structure 40 that includes a plurality of second lobes 42 extending radially inward from the second base structure 40. Each of the multiple second lobes 42 include a second mating surface contour on a top surface 44 that is configured to fit into the first mating surface contour of the bottom surface 36 in the male adapter 16 in FIG. 2. In an example, the second base structure 40 may include a hollow annular structure. As in the case of the male adapter 16 described above, the female adapter 18 is also welded internal to the pipe 14 as shown in FIG. 1. Accordingly, this may lead to a constriction in flow area of a liquid or gas through the pipe 14. Hence, providing a hollow structure for the female adapter 18 would minimize constriction in the flow of the liquid or gas.

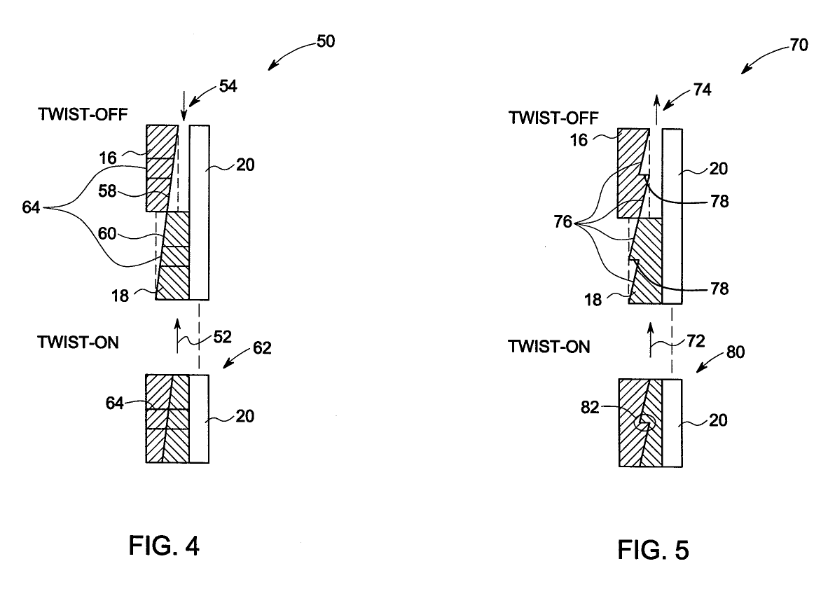

During coupling of the male adapter 16 with the female adapter 18, the first mating surface contour on the bottom surface 36 of the male adapter 16 is configured to twist on and twist off the second mating surface contour on the top surface 44 of the female adapter 18 in specific directions. While twisting on, the seal ring 20 as referenced to in FIG.1, which is disposed on the first base structure 30 is configured to compress so as to hold the female adapter 18 against the male adapter 16 in an equilibrium position. When the male adapter 16 is twisted on to the female adapter 18, the seal ring 20 gets compressed initially at least twice as much as that it would in the equilibrium position. Once the equilibrium position is reached, the seal ring 20 releases slightly so as to enable a tight connection between the male adapter 16 and the female adapter 18. Special contouring of the bottom surface 36 of the male adapter 16 in FIG. 2 and the top surface 44 of the female adapter 18 compresses the seal ring 20 desirably enough to enable required bonding at joints. Various embodiments of contouring of the bottom surface 36 and the top surface 44 are described in detail below in FIGS. 4, 5, 6 and 7.

In an illustrated embodiment of the invention as shown in FIG. 4, an exemplary configuration of the first mating surface contour on the bottom surface 36 of the male adapter 16 in FIG. 2 and the second mating surface contour on the top surface 44 of the female adapter 18 in FIG. 3 is provided. The exemplary configuration 50 is referred to as a dowel stop configuration. In the dowel stop configuration 50, the bottom surface 36 as referenced to in FIG. 2 of the male adapter 16 is twisted on in a direction 52 and twisted off in an opposite direction 54. In the dowel stop configuration 50, the first mating surface contour of the male adapter 16 and the second mating surface contour of the female adapter includes inclined planes 58 and 60 respectively. When the inclined planes 58 and 60 of the first mating surface contour and the second mating surface contour respectively, are aligned, the male adapter 16 and the female adapter 18 are in an unstable position. Hence, a dowel pinhole 64 is required in both the inclined planes 58 and 60 such that a dowel pin may be inserted to hold the male adapter 16 and the female adapter 18 together. The compressive annular ring 20 as referenced to in FIG. 1 is compressed so as to create a tight bond between the male adapter 16 and the female adapter 18 when twisted on as shown in a twist on configuration 62.

In another illustrated embodiment of the invention as shown in FIG. 5, an exemplary configuration of the first mating surface contour on the bottom surface 36 of the male adapter 16 in FIG. 2 and the second mating surface contour on the top surface 44 of the female adapter 18 in FIG. 3 is provided. The exemplary configuration 70 is referred to as a ratchet stop configuration. In the ratchet stop configuration 70, the bottom surface 36 as referenced to in FIG. 2 of the male adapter 16 as referenced to in FIG. 1 are twisted on in a direction 72 and twisted off in the same direction 72. In the ratchet stop configuration 70, the first mating surface contour of the male adapter 16 and the second mating surface contour of the female adapter 18 include two inclined planes 76 and a step 78 between the inclined planes 76. The step 78 allows twisting off the male adapter 16 in only one direction 74. During twist on, as the second mating surface contour of the female adapter 18 encounters the step 78 of the male adapter 16, the female adapter 18 falls in place and gets locked. If the female adapter 18 is further twisted in the same direction 72, it gets unlocked. However, there is no unlocking if twisted in an opposite direction. Such a configuration may be used in a pipe system where a torque is being applied on the pipes in a specific direction. In such a case, the ratchet stop configuration can be designed to twist off only in a direction opposite to the direction of the applied torque. The compressive annular ring 20 as referenced to in FIG. 1 facilitates in providing a tight bond at joint 82 between the male adapter 16 and the female adapter 18 when twisted on as seen in a twist on configuration 80.

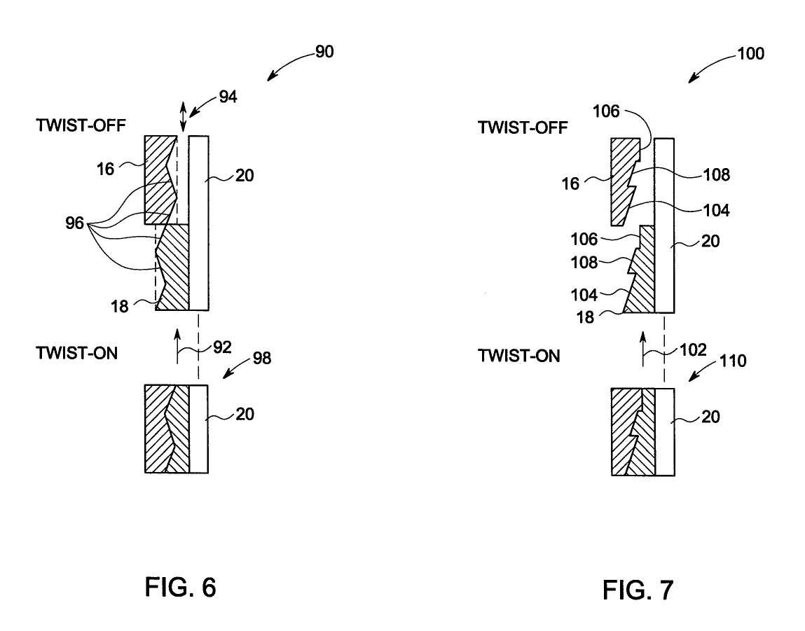

In another illustrated embodiment of the invention as shown in FIG. 6, an exemplary configuration 90 of the first mating surface contour on the bottom surface 36 of the male adapter 16 in FIG. 2 and the second mating surface contour on the top surface 44 of the female adapter 18 in FIG. 3 is provided. The exemplary configuration 90 is referred to as a two way release configuration. In the two way release configuration 90, the bottom surface 36 as referenced to in FIG. 2 of the male adapter 16 as referenced to in FIG. 1 may be twisted on in a direction 92 and twisted off in either direction 92 or 94. In the two way release configuration 90, the first mating surface contour of the male adapter 16 and the second mating surface contour of the female adapter includes three inclined planes 96. The three inclined planes 96 do not prevent twisting off in either direction, as there is no barrier like the step 78 in FIG. 5. Slope of the inclined planes 96 is directly proportional to torque applied during twisting on of the male adapter 16 and the female adapter 18. Hence, a gentler slope may be designed for an easier twist on process. The compressive annular ring 20 as referenced to in FIG. 1 facilitates in providing a tight bond between the male adapter 16 and the female adapter 18 when twisted on as seen in a twist on configuration 98.

In another illustrated embodiment of the invention as shown in FIG. 7, an exemplary configuration 100 of the first mating surface contour on the bottom surface 36 of the male adapter 16 in FIG. 2 and the second mating surface contour on the top surface 44 of the female adapter 18 in FIG. 3 is provided. The exemplary configuration 100 is referred to as a no way release configuration. In the no way release configuration 100, the bottom surface 36 as referenced to in FIG. 2 of the male adapter 16 as referenced to in FIG. 1 may be twisted on in a direction 102 and may not be twisted off in any direction. In the no way release configuration 100, the first mating surface contour of the male adapter 16 and the second mating surface contour of the female adapter 18 include an inclined plane 104, a straight plane 106 and a step 108 between the inclined plane 104 and the straight plane 106. The step 108 acts as a stop lock that locks the male adapter 16 and the female adapter 18 in place and does not give any degree of freedom to be twisted off. Hence, when the inclined planes 104 of the male adapter 16 and the female adapter 18 align, the step 108 locks the male adapter and the female adapter thus preventing them from twisting off. The compressive annular ring 20 as referenced to in FIG. 1 facilitates in providing a tight bond between the male adapter 16 and the female adapter 18 when twisted on as seen in a twist on configuration 110.

Some of the non-limiting advantages of the above mentioned connection system are non-inclusion of bolts or flanges to join parts in the system. In addition, the aforementioned embodiments of the invention may be fitted inside pipes or other systems that need to be connected thus enabling an easier process of assembly and disassembly.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A connector comprising:
a male adapter comprising a first base structure and a neck structure protruding out of the said base structure, said neck structure comprising a plurality of first lobes extending radially outward from the said neck structure, wherein said plurality of first lobes comprise a first mating surface contour on a bottom surface; and
a female adapter comprising a second base structure, said second base structure comprising a plurality of second lobes extending radially inward from the said second base structure having a second mating surface contour on a top surface, wherein said second mating surface contour is configured to fit into said first mating surface contour to induce a compressive stress between said male and said female adapter.

2. The connector of claim 1, wherein said plurality of the first lobes and the second lobes comprise at least two lobes.

3. The connector of claim 1, wherein said first mating surface contour comprises a dowel stop configured to twist on in one direction and twist off in an opposite direction.

4. The connector of claim 1, wherein said second mating surface contour comprises a dowel stop configured to twist on in one direction and twist off in an opposite direction.

5. The connector of claim 1, wherein said first mating surface contour comprises a ratchet stop configured to twist on in a direction and twist off in the same direction.

6. The connector of claim 1, wherein said second mating surface contour comprises a ratchet stop configured to twist on in a direction and twist off in the same direction.

7. The connector of claim 1, wherein said first mating surface contour comprises a two way release stop configured to twist on in a direction and twist off in either the same direction or an opposite direction.

8. The connector of claim 1, wherein said second mating surface contour comprises a two way release stop configured to twist on in a direction and twist off in either the same direction or an opposite direction.

9. The connector of claim 1, wherein said first mating surface contour comprises a no way release stop configured to twist on in a direction and twist off in no direction.

10. The connector of claim 1, wherein said second mating surface contour comprises a no way release stop configured to twist on in a direction and twist off in no direction.

11. The connector of claim 1, wherein said neck structure of the male adapter comprises a hollow annular structure.

12. The connector of claim 1, wherein said first base structure of the male adapter comprises a hollow annular structure;

13. The connector of claim 1, wherein said second base structure of the female adapter comprises a hollow annular structure.

14. The connector of claim 1, further comprising a compressive annular seal ring disposed on said first base structure of the male adapter and configured to compress so as to hold the female adapter against the male adapter and fit the female adapter into place.

15. A gasification system comprising:
a first end of a first gas pipe configured to connect to a male adapter comprising a first base structure and a neck structure protruding out of said base structure, said neck structure comprising a plurality of first lobes extending radially outward from said neck structure, wherein said plurality of first lobes comprise a first mating surface contour on a bottom surface; and
a first end of a second gas pipe configured to connect to said first end of the first gas pipe via a female adapter comprising a second base structure, said second base structure comprising a plurality of second lobes extending radially inward from the said second base structure having a second mating surface contour on a top surface, wherein said second mating surface contour is configured to fit into said first mating surface contour thereby compressing a face seal to induce a compressive stress between said male and said female adapter.

16. The gasification system of claim 15, further comprising a compressive annular seal ring disposed on said first base structure of the male adapter and configured to compress so as to hold the female adapter against the male adapter and fit the female adapter into place.

17. The gasification system of claim 15, wherein said plurality of the first lobes and the second lobes comprise at least two lobes.

18. The gasification system of claim 15, wherein said first mating surface contour comprises a dowel stop configured to twist on in one direction and twist off in an opposite direction.

19. The gasification system of claim 15, wherein said second mating surface contour comprises a dowel stop configured to twist on in one direction and twist off in an opposite direction.

20. The gasification system of claim 15, wherein said first mating surface contour comprises a ratchet stop configured to twist on in a direction and twist off in the same direction.

21. The gasification system of claim 15, wherein said second mating surface contour comprises a ratchet stop configured to twist on in a direction and twist off in the same direction.

22. The gasification system of claim 15, wherein said first mating surface contour comprises a two way release stop configured to twist on in a direction and twist off in either the same direction or an opposite direction.

23. The gasification system of claim 15, wherein said second mating surface contour comprises a two way release stop configured to twist on in a direction and twist off in either the same direction or an opposite direction.

24. The gasification system of claim 15, wherein said first mating surface contour comprises a no way release stop configured to twist on in a direction and twist off in no direction.

25. The gasification system of claim 15, wherein said second mating surface contour comprises a no way release stop configured to twist on in a direction and twist off in no direction.
